(19) United States
(12) Patent Application Publication
(10) Pub. No.: US 2010/0302177 A1
(43) Pub. Date: Dec. 2, 2010

(54) Method and apparatus for providing user interface based on contact position and intensity of contact force on touch screen

(75) Inventors: Jong Ho Kim, Daejeon (KR); Min Seok Kim, Daejeon (KR); Yon-Kyu Park, Daejeon (KR); Dae Im Kang, Daejeon (KR)

Correspondence Address: DeMont & Breyer, LLC, 100 Commons Way, Ste. 250, Holmdel, NJ, 07733, US

(73) Assignee: KOREAN RESEARCH INSTITUTE OF STANDARDS AND SCIENCE, Daejeon (KR)

(21) Appl. No.: 12/534,986

(22) Filed: Aug. 4, 2009

(30) Foreign Application Priority Data
Jun. 1, 2009 (KR) 10-2009-0047981

(51) Int. Cl. G06F 3/041

(52) U.S. Cl. 345/173

(57) ABSTRACT

A method and apparatus are disclosed providing a user interface using a touch input unit comprising a touch screen configured to detect a contact position and a contact force. The method comprises a step of the touch input unit receiving a touch input signal generated by a touch of a user's pointing object, a step of executing a step of a position processing unit identifying a contact position, corresponding to the received touch input signal, and a step of an intensity processing unit analyzing an intensity pattern of contact force, corresponding to the received touch input signal, simultaneously or sequentially, a step of a control unit determining an event corresponding to the touch input signal based on the identified contact position and the analyzed intensity pattern of contact force, and a step of an output unit outputting the determined event to a display screen.

### FIELD OF THE INVENTION

The present invention relates to a method and apparatus for providing a user interface through a touch screen and, more particularly, to a method and apparatus for providing a user interface based on a contact position and the intensity of contact force of a pointing object touching a touch screen.

### BACKGROUND OF THE INVENTION

In general, a touch screen is an input device that replaces the keyboard and the mouse and is configured to have a touch panel capable of detecting a user's touch attached on a monitor (e.g., a Liquid Crystal Display (LCD)), thereby enabling a user to perform a desired task. The touch screen is being used in, particularly, small-sized terminals having a limited size, such as portable phones, PMP, or MP3 players.

This touch screen is being used in the state of ON/OFF because consecutive data cannot be obtained in proportion to force by the contact of a pointing object (e.g., a stylus pen and a finger). In other words, since the touch screen is configured to detect only a contact position by determining only whether the pointing object has touched the touch screen, a user interface in a touch input device provides only limited functions. For example, in the case of iPhone available from Apple Inc., if it is sought to enlarge or reduce the screen using multi-touch while moving, both hands must be used. If it is sought to use a touch input device for measuring a position and force at the same time, the screen can be enlarged or reduced using only one hand using a force recognition function.

Accordingly, a variety of functions cannot be implemented through a user interface using a conventional touch input device. However, if a touch screen capable of obtaining information about a contact position and the intensity of force is used, a method of implementing a new user interface, suitable for more intuitive recognition, is made possible. Accordingly, the touch screen capable of obtaining information about a contact position and the intensity of force has been in the spotlight.

### SUMMARY OF THE INVENTION

Accordingly, the present invention has been made in view of the above problems occurring in the prior art, and it is an object of the present invention to provide a variety of user interface methods and apparatuses using a touch screen configured to obtain information about a contact position of a pointing object touching the touch screen and the intensity of contact force according to the contact.

It is another object of the present invention to provide an intuitive user interface method and apparatus using a touch screen configured to obtain information about a contact position of a touch screen and a pointing object and the intensity of contact force according to the contact.

According to an aspect of the present invention, there is provided a method of providing a user interface using a touch input unit 100 comprising a touch screen 130 configured to detect a contact position and a contact force, comprising: a step (S100) of the touch input unit 100 receiving a touch input signal generated by a touch of a user's pointing object 1; a step of executing a step (S200) of a position processing unit 200 identifying a contact position, corresponding to the received touch input signal, and a step (S300) of an intensity processing unit 300 analyzing an intensity pattern of contact force, corresponding to the received touch input signal, simultaneously or sequentially; a step (S400) of a control unit 400 determining an event corresponding to the touch input signal based on the identified contact position and the analyzed intensity pattern of contact force; and a step (S500) of an output unit 500 outputting the determined event to a display screen.

The step (S100) of the touch input unit 100 receiving the touch input signal preferably starts when the contact force has a minimum value or more and continues until the contact force becomes the minimum value or less after a lapse of a certain time.

Further, the step (S200) of the position processing unit 200 identifying the contact position corresponding to the received touch input signal preferably starts when the contact force has a minimum value or more and continues until the contact force becomes the minimum value or less after a lapse of a certain time.

Further, the step (S300) of the intensity processing unit 300 analyzing the intensity pattern of contact force corresponding to the received touch input signal preferably starts when the contact force has a minimum value or more and continues until the contact force becomes the minimum value or less after a lapse of a certain time.

The event preferably updates the display screen by converting coordinates of the identified contact position on the basis of the touch screen 130.

Further, the event preferably updates the display screen by zooming in or zooming out the display screen.

The touch screen 130 preferably displays a toggle button 110 configured to select any one of the zoom-in event and the zoom-out event.

Further, the intensity pattern of contact force preferably includes information about the intensity of contact force for the received touch input signal, and the display screen is updated in proportion to the information about the intensity of contact force.

Further, the intensity pattern of contact force preferably includes a drag & drop pattern for a first contact position, corresponding to a first touch input signal, and a second contact position corresponding to a second touch input signal. The event preferably updates a display screen, corresponding to the first contact position, to a display screen corresponding to the second contact position.

The intensity pattern of contact force preferably is pattern information about the intensity of contact force having a finite value less than a critical value after the intensity of contact force having the critical value or more is applied.

The drag & drop pattern preferably is pattern information in which a change from the first contact position to the second contact position is based on any one of a change from the left to the right, a change from the right to the left, a change from the top to the bottom, a change from the bottom to the top, and a change in a diagonal direction.

The display screen corresponding to the second contact position preferably is the display screen for a previous or next page on the display screen.

According to another aspect of the present invention, there is provided an apparatus for providing a user interface based on a contact position and an intensity of contact force on a touch screen, comprising: a touch input unit 100 comprising tactile sensors 140 each configured to receive a touch input signal generated by a touch of a user's pointing object 1; a position processing unit 200 configured to identify a contact position corresponding to the received touch input signal; an intensity processing unit 300 configured to analyze an intensity pattern of contact force, corresponding to the received touch input signal, based on an output signal of each of the tactile sensors 140; a control unit 400 configured to determine an event corresponding to the touch input signal based on the identified contact position and the analyzed intensity pattern of contact force; and an output unit 500 configured to output the determined event to a display screen.

The touch input unit 100 preferably comprises a contact resistance-type touch screen or a capacitive type touch screen.

The touch input signal preferably is touch input signal information corresponding to the contact force and the contact position.

### BRIEF DESCRIPTION OF THE DRAWINGS

Further objects and advantages of the invention can be more fully understood from the following detailed description taken in conjunction with the accompanying drawings in which:

FIG. 1 is a block diagram showing the construction of a user interface apparatus according to an exemplary embodiment of the present invention;

FIG. 2a shows a basic construction of a touch input unit shown in FIG. 1;

FIG. 2b is a front view showing a state in which a touch screen equipped with tactile sensors is mounted on a portable phone terminal;

FIG. 2c is a lateral view of each of the tactile sensors shown in FIG. 2a;

FIG. 3a is a flowchart illustrating a method of providing a user interface according to an exemplary embodiment of the present invention;

FIG. 3b is a diagram showing an event occurrence condition in the form of three-dimensional coordinates having contact force as a height axis on the plane of a touch screen which is expressed by a certain axis (X axis) and an axis (Y axis) orthogonal to the certain axis;

FIGS. 4(a), 4(b), and 4(c) are diagrams showing display screens illustrating examples of zoom-in and zoom-out events (i.e., events generated by a user interface method according to the present invention);

FIG. 5 is a graph showing the output of the tactile sensor for the intensity of contact force when executing zoom-in and zoom-out events;

FIGS. 6(a) and 6(b) are diagrams showing display screens illustrating a screen movement event by drag & drop, from among events generated by the user interface method according to the present invention;

FIG. 7 is a graph showing an intensity pattern of contact force for executing a screen movement event;

FIGS. 8(a), 8(b), and 8(c) are diagrams showing display screens illustrating a page movement event by drag & drop, from among events generated by the user interface method according to the present invention; and

FIG. 9 is a graph showing an intensity pattern of contact force for executing a page movement event.

### DETAILED DESCRIPTION OF THE PREFERRED EMBODIMENT

Some embodiments of the present invention will now be described in detail with reference to the accompanying drawings.

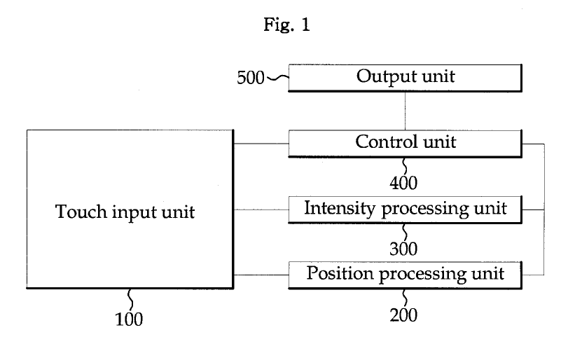

FIG. 1 is a block diagram showing the construction of a user interface apparatus according to an exemplary embodiment of the present invention. Referring to FIG. 1, the user interface apparatus according to the exemplary embodiment of the present invention includes a touch input unit 100, a position processing unit 200, an intensity processing unit 300, a control unit 400, and an output unit 500.

The touch input unit 100 is configured to receive a touch input signal detected by a touch screen 130 configured to detect a position and force at the same time when a user's pointing object 1 (e.g., a stylus pen or a finger) touches the touch screen 130. Although the present embodiment illustrates the touch screen for detecting a position and force using tactile sensors 140 based on a contact resistance method, the touch input unit 100 may have a construction (not shown) including a touch screen for detecting a position and force based on a capacitive method. Hereinafter, an example in which the touch input unit 100 is configured to detect a contact position and the intensity of contact force is described.

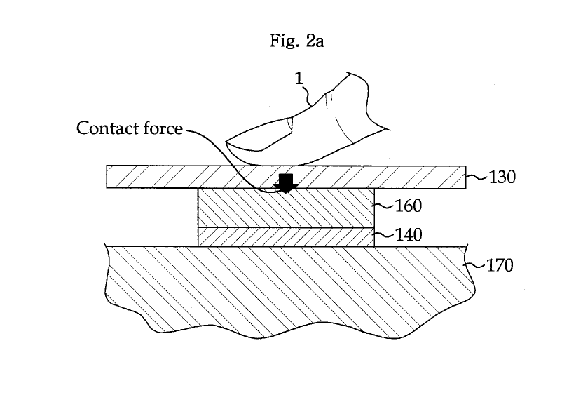

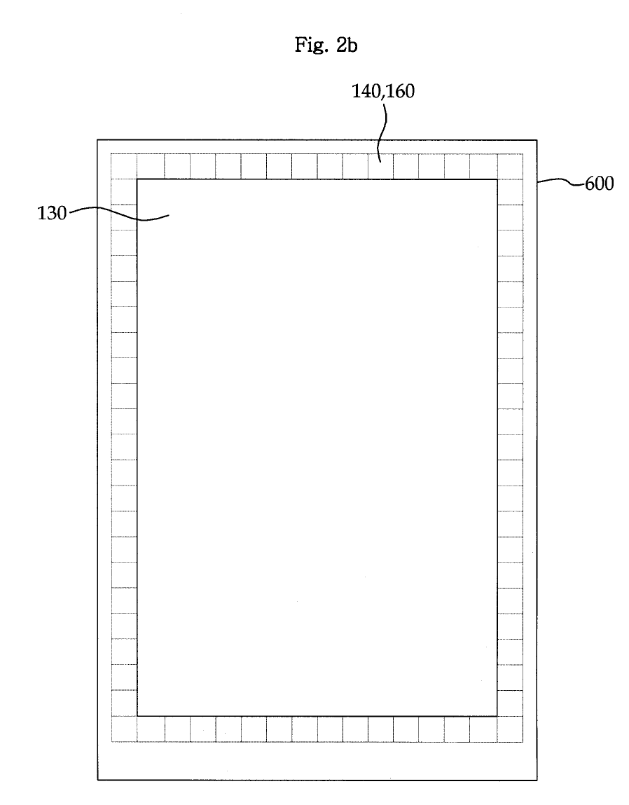

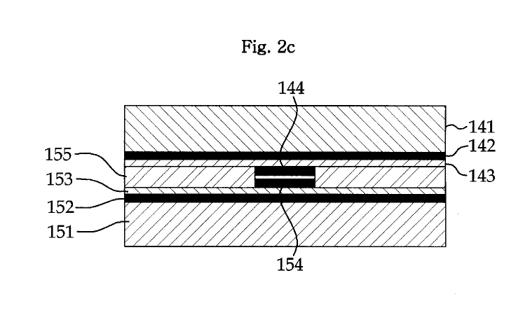

The touch screen 130 and the tactile sensors 140 are described in detail below with reference to FIGS. 2a, 2b and 2c.

The position processing unit 200 is configured to identify a contact position corresponding to a received touch input signal. The position processing unit 200 is configured to identify a position of the pointing object 1 in the form of a coordinate value. The coordinates may be represented using a variety of coordinate systems and may be represented using, for example, an orthogonal coordinate system (x-y coordinates).

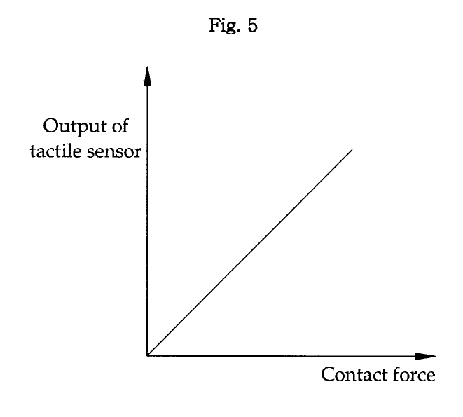

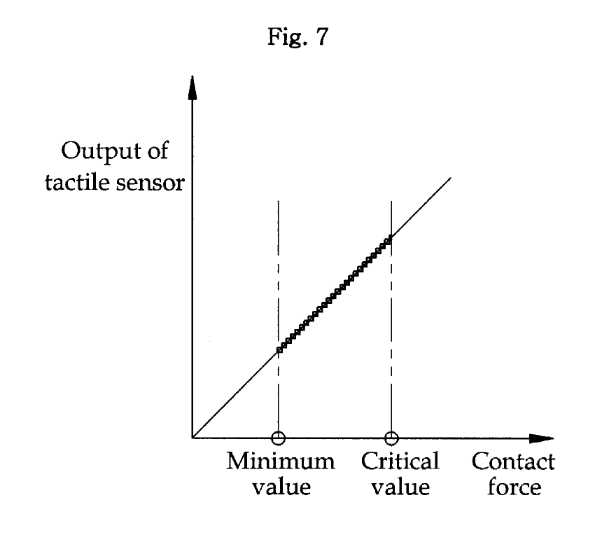

The intensity processing unit 300 is configured to analyze an intensity pattern of contact force corresponding to a received touch input signal. The intensity processing unit 300 is configured to acquire the intensity of contact force of the pointing object 1, coming into contact with the touch screen 130, based on the output signal of the tactile sensor 140. The intensity processing unit 300 analyzes an intensity pattern of contact force based on the acquired intensity of contact force. The intensity of contact force and pattern information thereof may be obtained through an operation or may be obtained by searching for a previously stored data value. Alternatively, an operation and search for a data value may be used at the same time. Here, the intensity pattern of contact force is a result of materializing consecutive changes in the intensity of contact force. The intensity of an output signal of the tactile sensor 140 is consecutively changed in proportion to the consecutive changes in the intensity of contact force (refer to FIGS. 5 and 7), and a result of materializing the consecutive changes in the intensity of the output signal appears as the intensity pattern of contact force.

The control unit 400 is configured to determine an event corresponding to the touch input signal for the touch screen based on the identified contact position and the analyzed intensity pattern of contact force. According to an exemplary embodiment of the present invention, events, such as zoom-in/zoom-out, screen movement, and page movement, are determined.

The output unit 500 is configured to output the event determined by the control unit 400 to a display screen through a LCD, OLED, PDP or the like.

FIG. 2a shows a basic construction of the touch input unit 100 including the touch screen 130 equipped with the tactile sensor 140. The touch input unit 100 to which contact force is applied from the pointing object 1 includes the touch screen 130 (i.e., a medium configured to recognize position information) and a number of the tactile sensors 140 placed under the touch screen 130 and each configured to detect contact force and output a specific signal. The touch input unit 100 may further include actuators 160 configured to output vibration in order to give a feeling of click to a user.

The touch screen 130 is an input medium configured to give a variety of event execution commands on a display based on the position of the pointing object 1 coming into contact with the touch screen 130. In particular, the touch screen 130 may be used in small-sized terminals, such as portable phones, PMP, and MP3 players. Furthermore, the touch screen may be a touch screen which is used in a Liquid Crystal Display (LCD), an Organic Light Emitting Diode (OLED), a Plasma Display Panel (PDP), and an electronic ink display device. Alternatively, the touch screen may be a flexible touch screen. The recognition of position information about the pointing object 1, applied to the touch screen, and the characteristics of a LCD, an OLED, a PDP, and an electronic ink display device are well known in the art, and a detailed description thereof is omitted.

A detailed construction of the tactile sensors 140 coupled to the touch screen 130 is described later with reference to FIG. 2c.

FIG. 2b is a front view showing a state in which the touch screen 100 equipped with the tactile sensors 140 is mounted on a portable phone terminal. Referring to FIG. 2b, in the state in which one tactile sensor 140 and one actuator 160 constitute one unit body, a number of the unit bodies are arranged in the lower circumference of the touch screen. This construction may function to prevent damage to display function and also detect contact force in a multi-touch or drag situation of the pointing object 1.

FIG. 2c is a lateral view of each of the tactile sensors 140 shown in FIG. 2a. The tactile sensor 140 includes an upper plate and a lower plate. The upper plate includes a coating layer 142 and a metal layer 143, sequentially formed over a polymer film 141 having a certain thickness, and a resistant material 144 formed on the metal layer 143. The lower plate includes a coating layer 152 and a metal layer 153, sequentially formed over a polymer film 151 having a certain thickness, and a resistant material 154 formed on the metal layer 153. The tactile sensor 140 further includes a spacer 155 bonded to the upper and lower plates so that the resistant material 144 of the upper plate and the resistant material 154 of the lower plate are opposite to each other.

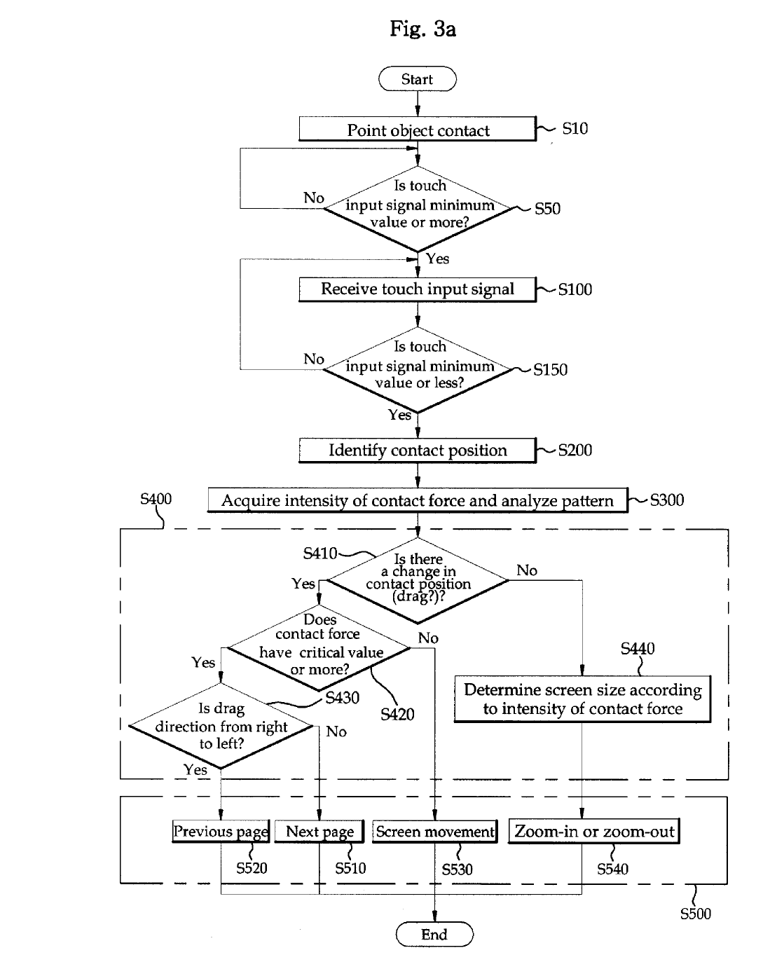

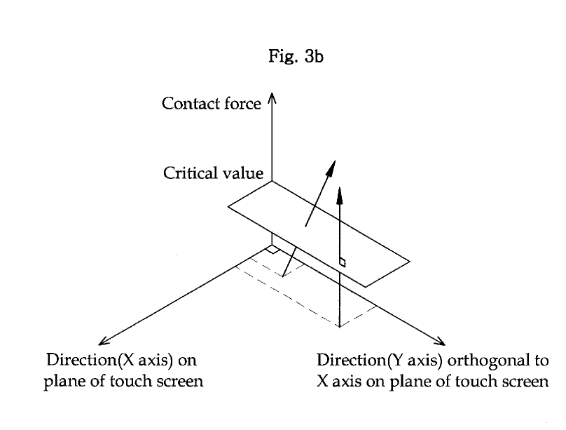

FIG. 3a is a flowchart illustrating a method of providing a user interface according to an exemplary embodiment of the present invention, and FIG. 3b is a diagram showing an event occurrence condition in the form of three-dimensional coordinates having contact force as a height axis on the plane of a touch screen which is expressed by a certain axis (X axis) and an axis (Y axis) orthogonal to the certain axis. In particular, two vectors each having an arrow shape, shown on the three-dimensional coordinates of FIG. 3b, are based on whether there is a drag on the position coordinates (a change in the contact position) and whether the intensity of contact force having a critical value or more has been applied in order to facilitate the understanding of the present embodiment.

A schematic sequence of generating an event is described below with reference to FIGS. 3a and 3b.

A touch input signal, generated by the touch (S10) of a user's pointing object 1, is received through the touch screen of the touch input unit 100 at step S100. The position processing unit 200 identifies a contact position corresponding to the received touch input signal at step S200. The intensity processing unit 300 then analyzes an intensity pattern of contact force, corresponding to a change in the output intensity of the tactile sensor 140, based on the touch input signal at step S300.

Incidentally, in the step S100 of receiving the touch input signal of the touch input unit 100, the touch input signal may be received only when the contact force has a minimum value or more in order to prevent the occurrence of malfunction at step S50. In this case, it is determined whether the contact force has the minimum value or more at specific time intervals. If, as a result of the determination, the contact force is determined to have less than the minimum value, the process is prevented from entering the next step S100 through an unlimited loop circuit (not shown). However, if, as a result of the determination, the contact force is determined to have the minimum value or more, the process proceeds to the next step S100.

Next, when the intensity of contact force drops to the minimum value or less, the step S200 of the position processing unit 200 identifying the contact position and the step S300 of the intensity processing unit 300 analyzing the intensity pattern of contact force are carried out. Here, a change in the contact force for the time from a point of time at which the intensity of contact force begins having the minimum value or more to a point of time at which the intensity of contact force has the minimum value or less becomes the intensity pattern of contact force.

Alternatively, only when the contact force has the minimum value or more, the step S200 of the position processing unit 200 identifying the contact position and the step S300 of the intensity processing unit 300 analyzing the intensity pattern of contact force may be carried out. The flowchart of FIG. 3a is based on the former case (steps S50 and S150).

Here, the occurrence of a zoom-in or zoom-out event has the following process.

The control unit 400 determines whether there is a change in the contact position (i.e., a drag) identified through an orthogonal coordinate system at step S410. If, as a result of the determination, there is no change in the contact position, information about the intensity pattern of contact force, analyzed by the intensity processing unit 300, is received, and the size of a screen according to the intensity of contact force is determined based on the information at step S440. The output unit 500 generates a zoom-in or zoom-out event at step S540.

The zoom-in or zoom-out event has to be first selected based on a touch input signal generated by a user's behavior, such as pressing a toggle button 110 on the touch screen.

The occurrence of a screen movement event has the following process.

If, as a result of the determination at step S410, there is a change in the contact position (i.e., a drag & drop pattern), information about the intensity pattern of contact force, analyzed by the intensity processing unit 300, is received, and it is then determined whether the intensity pattern of contact force has less than a preset critical value based on the information at step S420. Only when the intensity pattern of contact force has less than the preset critical value as a result of the determination at step S420, a display screen corresponding to the first contact position is updated to a screen corresponding to a second contact position. That is, in the present embodiment, the output unit 500 is configured to generate a display screen movement event at step S530.

The occurrence of a page movement event of a web page has the following process.

If, as a result of the determination at step S410, there is a change in the contact position (i.e., a drag & drop pattern), information about the intensity pattern of contact force, analyzed by the intensity processing unit 300, is received, and it is then determined whether the intensity pattern of contact force has a preset critical value or more at step S420. If, as a result of the determination, the intensity pattern of contact force is determined to have the preset critical value or more, it is determined whether a change in the drag direction is the pattern information based on any one of a change from the left to the right, a change from the right to the left, a change from the top to the bottom, a change from the bottom to the top, and a change in a diagonal direction at step S430. If, as a result of the determination, the change in the drag direction is the pattern information based on any one of the changes, a display screen corresponding to the first contact position is updated to a screen corresponding to the second contact position. In the present embodiment, the output unit 500 is configured to generate a switch event to a previous or next page on a web page at steps S510 and S520. In particular, when a drag direction is from the right to the left, the previous page is displayed at step S520.

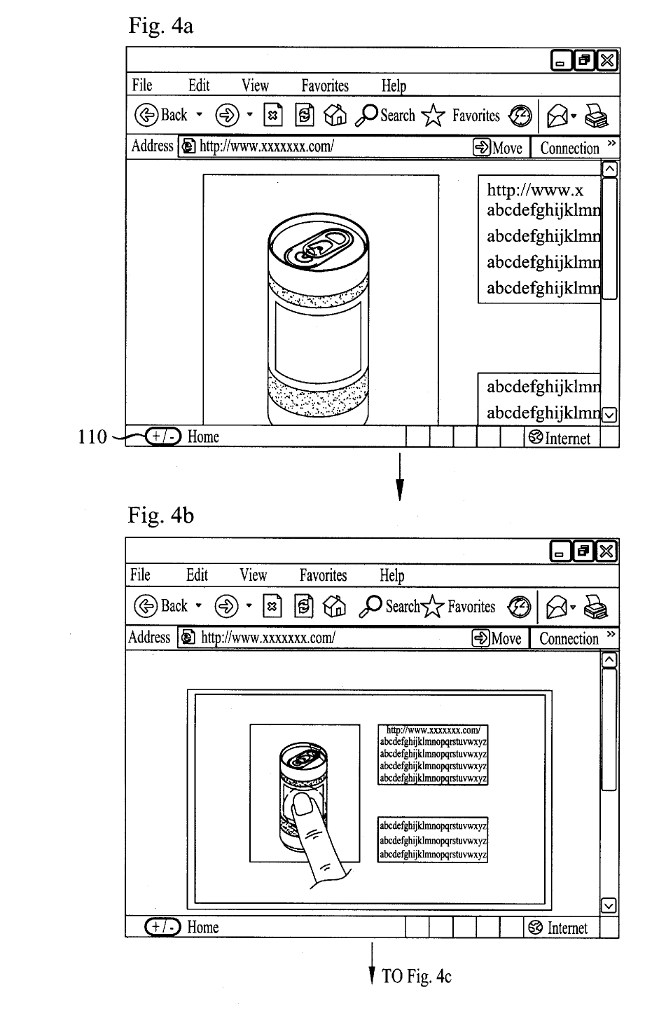

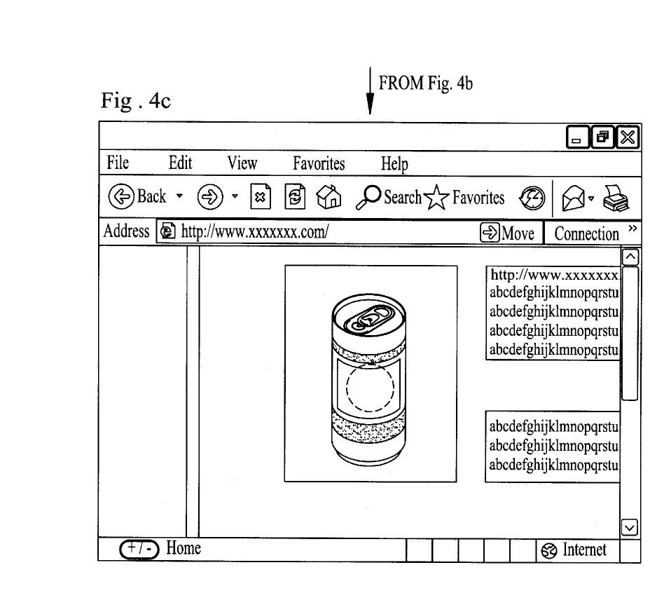

FIGS. 4(a), 4(b), and 4(c) are diagrams showing display screens illustrating examples of zoom-in and zoom-out events (i.e., events generated by a user interface method according to the present invention).

In a method of updating a display screen of FIG. 4(a) to a display screen of FIG. 4(b), as described above with reference to FIG. 3, the pointing object 1 touches one point on the touch screen. When the pointing object 1 falls from the touch screen, coordinates of the contact position on the display screen are converted into a center point of the touch screen, and the display screen is then updated to a zoom-out display screen. In this case, when the display screen exceeds a limit, it is updated to a maximum screen because the size of the screen is limited.

A zoom-in event execution method of updating a display screen of FIG. 4(b) to a display screen of FIG. 4(c) is identical to the method of generating the zoom-out event except that the zoom-in event is selected by the toggle button 110 and then executed.

FIG. 5 is a graph showing the output of the tactile sensor for the intensity of contact force when executing zoom-in and zoom-out events. The traverse axis indicates the intensity of contact force, and the vertical axis indicates the output of the tactile sensor 140. Solid line indicates a proportional relationship between the contact force and the output of the tactile sensor 140.

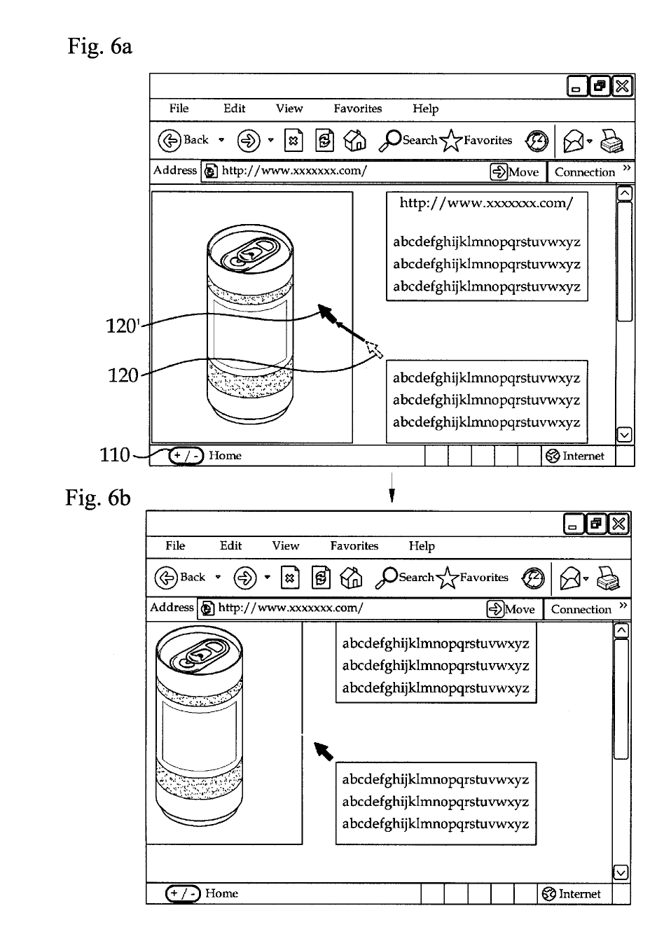

FIGS. 6(a) and 6(b) are diagrams showing display screens illustrating a screen movement event by drag & drop, from among events generated by the user interface method according to the present invention.

In a process of updating a display screen of FIG. 6(a) to a display screen of FIG. 6(b), as described above with reference to FIG. 3, the pointing object 1 touches one point on the touch screen. When contact force having less than a critical value is applied and a drag & drop pattern is generated, the display screen of FIG. 6(a) corresponding to a first contact position is updated to the display screen of FIG. 6(b) corresponding to a second contact position. That is, the screen is moved.

In order to facilitate the understanding of the screens according to the embodiment, an indicator 120 is shown in FIG. 6(a). A first contact position indicator 120 is indicated by dotted line, and a second contact position indicator 120′ is indicated by solid line.

FIG. 7 is a graph showing an intensity pattern of contact force for executing a screen movement event. The traverse axis indicates the intensity of contact force, and the vertical axis indicates the output of the tactile sensor 140. Solid line indicates a proportional relationship between the contact force and the output of the tactile sensor 140. As shown in FIG. 7, the intensity of contact force corresponding to the output signal (bold line) of the tactile sensor 140 ranges from a minimum value or more to less than a critical value.

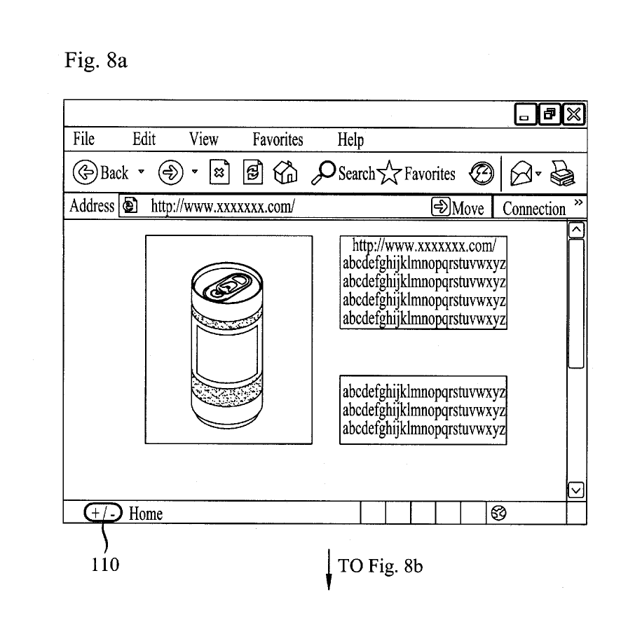

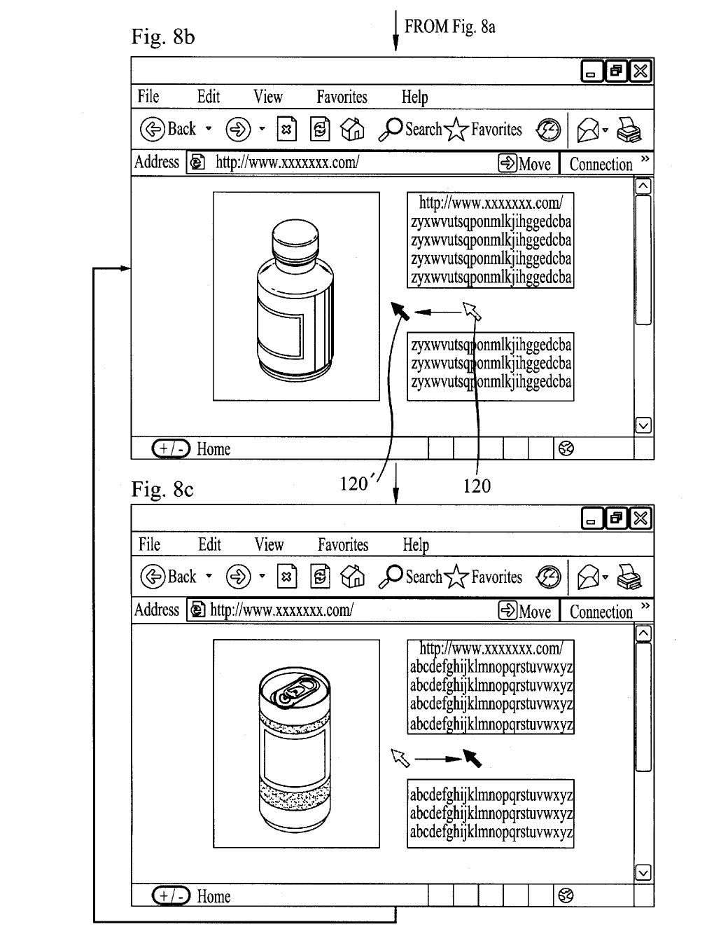

FIGS. 8(a), 8(b), and 8(c) are diagrams showing display screens illustrating a page movement event by drag & drop, from among events generated by the user interface method according to the present invention.

FIG. 8(a) shows a first page, FIG. 8(b) shows a second page, and FIG. 8(c) shows a third page. The first to third pages are sequentially illustrated in sequence of time. That is, FIG. 8 shows a page update method from the display screen of FIG. 8(a), corresponding to a first contact position, to the display screen of FIG. 8(b) corresponding to a second contact position and an update event method from the display screen of FIG. 8(b) to the display screen of FIG. 8(a). In the update method, as described above with reference to FIG. 2, the pointing object 1 touches one point on the touch screen. A drag & drop pattern is then generated from the left to the right. After a lapse of a certain time with the contact force having a critical value or more, when the intensity of the contact force drops to a minimum value or less, the display screen of FIG. 8(a) corresponding to a first contact position is updated to the display screen of FIG. 8(b) corresponding to a second contact position. In other words, a current page (the first page) display screen is switched to a next page (the second page) display screen. However, if, in the display screen of FIG. 8(b), the first contact position is changed to the second contact position and a drag & drop pattern is generated from the right to the left, and the intensity of contact force has the critical value or more, a display screen is updated to the display screen of FIG. 8(c) (i.e., the previous page (the third page)).

In order to facilitate the understanding of the screens according to the embodiment, an indicator 120 is shown in FIG. 8. A first contact position indicator 120 is indicated by dotted line, and a second contact position indicator 120′ is indicated by solid line.

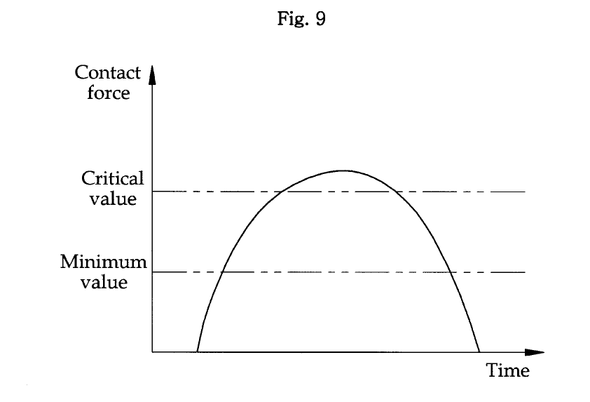

FIG. 9 is a graph showing an intensity pattern of contact force for executing a page movement event. The traverse axis indicates the time, and the vertical axis indicates the contact force. The graph indicated by solid line shows a change in the contact force according to the time. The graph shows the intensity pattern of contact force described above with reference to FIG. 8.

The present invention is not limited to the embodiments in the web pages shown in the drawings, but may be applied to a variety of display screens, including photographs and games. The present invention may be modified in various ways within the scope of the present invention as well as the above-described embodiments.

The present invention may be implemented in a computer readable recording medium in the form of computer readable codes. The computer readable recording medium may include all types of recording devices for storing data which are readable by computer systems. Examples of the computer readable recording medium may include ROM, RAM, CD-ROM, magnetic tapes, hard disks, floppy disks, flash memory, optical data storage devices, and ones implemented in the form of carrier waves (e.g., transmission over the Internet). The computer readable recording medium may be distributed over network coupled computer systems and may be stored and executed in the form of computer readable codes in a distributed fashion.

According to the embodiments of the present invention, a variety of user interface methods and apparatuses can be provided based on information about the contact position of a pointing object touching a touch screen and the intensity of the contact force. Accordingly, there is an advantage in that various terminals to which the present invention is applied can find wide applications.

Further, an intuitive user interface can be implemented based on information about a contact position of a pointing object touching a touch screen and the intensity of the contact force. Accordingly, there is an advantage in that user convenience can be increased.

While some embodiments of the present invention have been described, the present invention is not to be restricted by the embodiments but only by the appended claims. It is to be appreciated that those skilled in the art can change or modify the embodiments without departing from the scope and spirit of the present invention.

1. A method of providing a user interface using a touch input unit comprising a touch screen configured to detect a contact position and a contact force, the method comprising:
receiving, at the touch input unit, a touch input signal generated by a touch of a user's pointing object;
executing a step of a position processing unit identifying a contact position, corresponding to the received touch input signal, and a step of an intensity processing unit analyzing an intensity pattern of contact force, corresponding to the received touch input signal, simultaneously or sequentially;
determining, at a control unit, an event corresponding to the touch input signal based on the identified contact position and the analyzed intensity pattern of contact force; and
outputting, at an output unit, the determined event to a display screen.

2. The method as claimed in claim 1, wherein the receiving of the touch input signal starts when the contact force has a minimum value or more and continues until the contact force becomes the minimum value or less after a lapse of a certain time.

3. The method as claimed in claim 1, wherein the identifying of the contact position corresponding to the received touch input signal starts when the contact force has a minimum value or more and continues until the contact force becomes the minimum value or less after a lapse of a certain time.

4. The method as claimed in claim 1, wherein the analyzing of the intensity pattern of contact force corresponding to the received touch input signal starts when the contact force has a minimum value or more and continues until the contact force becomes the minimum value or less after a lapse of a certain time.

5. The method as claimed in claim 1, wherein the event updates the display screen by converting coordinates of the identified contact position on the basis of the touch screen.

6. The method as claimed in claim 1, wherein the event updates the display screen by zooming in or zooming out the display screen.

7. The method as claimed in claim 6, wherein the touch screen displays a toggle button configured to select any one of the zoom-in event and the zoom-out event.

8. The method as claimed in claim 6, wherein:
the intensity pattern of contact force includes information about an intensity of contact force for the received touch input signal, and
the display screen is updated in proportion to the information about the intensity of contact force.

9. The method as claimed in claim 1, wherein:
the intensity pattern of contact force includes a drag & drop pattern for a first contact position, corresponding to a first touch input signal, and a second contact position corresponding to a second touch input signal, and
the event updates a display screen, corresponding to the first contact position, to a display screen corresponding to the second contact position.

10. The method as claimed in claim 9, wherein the drag & drop pattern is pattern information in which a change from the first contact position to the second contact position is based on any one of a change from a left to a right, a change from a right to a left, a change from a top to a bottom, a change from a bottom to a top, and a change in a diagonal direction.

11. The method as claimed in claim 9, wherein the display screen corresponding to the second contact position is the display screen for a previous or next page on the display screen.

12. An apparatus for providing a user interface based on a contact position and an intensity of contact force on a touch screen, the apparatus comprising:
a touch input unit comprising tactile sensors each configured to receive a touch input signal generated by a touch of a user's pointing object;
a position processing unit configured to identify a contact position corresponding to the received touch input signal;
an intensity processing unit configured to analyze an intensity pattern of contact force, corresponding to the received touch input signal, based on an output signal of each of the tactile sensors;
a control unit configured to determine an event corresponding to the touch input signal based on the identified contact position and the analyzed intensity pattern of contact force; and
an output unit configured to output the determined event to a display screen.

13. The apparatus as claimed in claim 12, wherein the touch input unit comprises a contact resistance-type touch screen or a capacitive type touch screen capable of detecting a position and force.

14. The apparatus as claimed in claim 12, wherein the touch input signal is touch input signal information corresponding to the contact force and the contact position.
